(19) United States
(12) Patent Application Publication
(10) Pub. No.: US 2025/0134060 A1
(43) Pub. Date: May 1, 2025

(54) Flexible Dynamic Transportable Corral

(71) Applicant: Jon Davis Mollhagen, Lorraine, KS (US)

(72) Inventor: Jon Davis Mollhagen, Lorraine, KS (US)

(21) Appl. No.: 18/827,308

(22) Filed: Sep. 6, 2024

Related U.S. Application Data
(60) Provisional application No. 63/546,163, filed on Oct. 27, 2023.

(51) Int. Cl. A01K 3/00; E04H 17/18

(52) U.S. Cl. CPC A01K 3/001; E04H 17/185

(57) ABSTRACT

A transportable corral includes a plurality of fence panels that are hinged to each other in an end-to-end manner which can be selectively folded together and latched to reduce a perimeter or fence length. Each panel includes a wheel assembly that presents a slick steel wheel with curved sidewalls that is able to roll for moving a panel in a normal direction or slide like a skid for sideways movement. Each panel also includes a brace assembly that is jointed for folding and collapsing when the panel is subjected to excessive outward forces.

### CROSS REFERENCES TO RELATED APPLICATIONS

This application claims the benefit of United States Provisional Utility Patent Application No. 63/546,163 filed on Oct. 27, 2023 which was titled Brace Assembly for Fence Panels and which is incorporated herein by reference as if repeated verbatim hereinafter.

This application also incorporates by reference U.S. Pat. No. 11,242,696 which issued on Feb. 8, 2022

### FIELD

The present invention relates to a transportable corral structure that is has panels that are able to be arranged in an enclosing corral configuration and further able to be moved and rearranged in order to change the area of the corral.

### BACKGROUND

Those who transport livestock animals often have a need to enclose them in an open area after arriving at a destination. What is needed is a corral structure that is able to be folded into a relatively compact configuration that is then able to loaded onto a trailer for transport. Still further, what is needed is a corral structure comprised of hinged panels which are each supported by at least one wheel and at least one outwardly extending collapsable kickstand, such that it is possible for operators to move adjacent fence panels so that adjacent fence panels are folded and latched to each other so that the area of the corral is able to be incrementally or gradually changed.

### SUMMARY

The above noted need for a transportable corral is addressed by a transportable corral as is described in U.S. Pat. No. 11,242,696 which issued on Feb. 8, 2022 which is incorporated herein by reference. As is described in the above referenced US Patent, a transportable corral is comprised of a plurality of fence panels that are hinged to each other in an end-to-end manner. Manually releasable panel latches are mounted to the fence panels that are arranged to automatically engage and latch with an adjacent fence panel so that the fence panels are able to be folded into a compact arrangement for transport and for other purposes as will be described below. Retractable wheel assemblies are mounted to the fence panels to facilitate movement and relocation of the folded arrangement or of individual fence panels. The panel latches are able to be released sequentially to permit each fence panel to be unfolded from the compact arrangement into an extended position. Once the fence panels have been deployed, it is possible to arrange the fence panels into an enclosed corral configuration. Once the fence panels have been arranged into an enclosing corral configuration, the wheel of each panel may be retracted so that each fence panel is able to rest directly on the ground. Each fence panel is also provided with a retractable strut that is able to be pivoted into an extended position toward the exterior of the corral. Each strut braces each fence panel from forces that may be applied from the interior of the corral by livestock animals enclosed within the corral.

The second need noted above is met by new embodiment of a transportable corral that is also flexible and which can be re-sized and reconfigured with a minimum of effort in order to control and move livestock. In the new embodiment, adjacent panels are preferably supported by wheel assemblies that are in an extended in-use position. As before, fence panels are able to be latched together, however, with the new embodiment, it is easier to fold adjacent panels together such that it is possible to reduce the area of the corral in a gradual, incremental manner. To facilitate such a flexible versatile transportable corral, the retractable but rigid brace assemblies are replaced by jointed, collapsable brace assemblies. Still further, the standard steel wheels which have a simple cylindrical shape (as shown in FIG. 6 of U.S. Pat. No. 11,242,696) have been replaced by steel wheels 562 having curved edges 562B as shown in FIG. 5B of the present application. New wheels 562 are able to slide sideways as if they were steel skids. The new jointed, collapsable brace assemblies are able to resist livestock that are applying pressure to fence panels. However, if livestock apply excessive pressure to a fence panel, then the jointed, collapsable brace assembly will fold under the fence panel and allow the fence panel to yield until the brace is reset by an operator. The configuration of the new jointed collapsable brace assemblies and the new steel wheels with curved edges and how they facilitate the safe enclosure of livestock animals and how the size of a corral may be gradually reduced by the actions of operators in order to coax livestock animals to calmly exit the corral will be described in greater detail below.

### BRIEF DESCRIPTION OF THE DRAWINGS

FIG. 1 is a perspective view of a transportable fence consisting of a plurality of fence panels that have been arranged to define an enclosure for enclosing livestock animals.

FIG. 2 is an end view of a fence panel with a brace assembly showing the brace assembly in the extended supporting position.

FIG. 2A is a close-up view of the joint of the brace assembly taken from indicated area 2A of FIG. 2.

FIG. 3 is an end view of a fence panel with a brace assembly showing the brace assembly in the extended supporting position as a force F is being applied to the fence panel as the fence panel is lifted and translated and as the brace assembly pivots toward the fence panel.

FIG. 4 is an end view of a fence panel with a brace assembly showing the brace assembly in the extended supporting position as a force F is continuing to be applied to the fence panel as the fence panel is lifted and translated and as the brace assembly pivots toward the fence panel until the joint of the brace assembly and the bottom rail of the fence panel come into contact with each other.

FIG. 5 is an end view of a fence panel with a brace assembly showing the brace assembly in an extended position after the joint of the brace assembly has articulated to allow the distal end of the brace assembly to fold under the bottom rail of the fence panel.

FIG. 5A is a plan view of a fence panel showing a wheel assembly mounted to the fence panel.

FIG. 5B is a perspective view of the wheel from the wheel assembly of FIG. 5A.

FIG. 5C is a side view of the wheel from the wheel assembly of FIG. 5A.

FIG. 5D is an end view of the wheel from the wheel assembly of FIG. 5A.

FIG. 6 is an end view of a fence panel showing an operator pushing and moving the fence panel.

FIG. 7 is a perspective view of a portion of a corral fence showing an operator in the act of pushing and moving the fence panel.

FIG. 8 is a side view showing a livestock animal in close proximity to a fence panel.

FIG. 9 is a side view showing a livestock animal which is in close proximity to a fence panel and which is applying a force to the fence panel thereby causing the fence panel to lift as the brace assembly rotates.

FIG. 10 is a side view showing a livestock animal which is in close proximity to a fence panel and which has applied a force to the fence panel and caused the fence panel to lift and the brace assembly to fold so that the distal end of the brace assembly is folded under the fence panel.

FIG. 11 is a perspective view of a fully deployed transportable corral which has collapsable brace assemblies and which encloses numerous livestock animals and which presents an exit opening.

FIG. 12 is a perspective view of a fully deployed transportable corral as shown in FIG. 11 but with fewer livestock animals enclosed therein thereby illustrating how a large pen that encloses a small number of livestock animals may provide an opportunity for a livestock animal to run and attempt to jump over a fence panel.

FIG. 13 is a perspective view of the transportable corral shown in FIG. 12 after operators have folded and latched adjacent fence panels together in order to reduce the perimeter of the corral and thereby reduced the enclosed area so that each livestock animal is not afforded sufficient area to run and attempt to jump over a panel and so that the enclosed livestock animals are urged to walk out through the exit.

### DETAILED DESCRIPTION

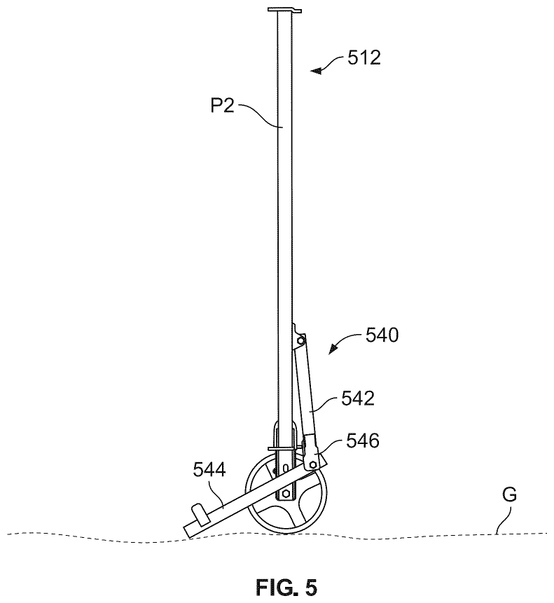

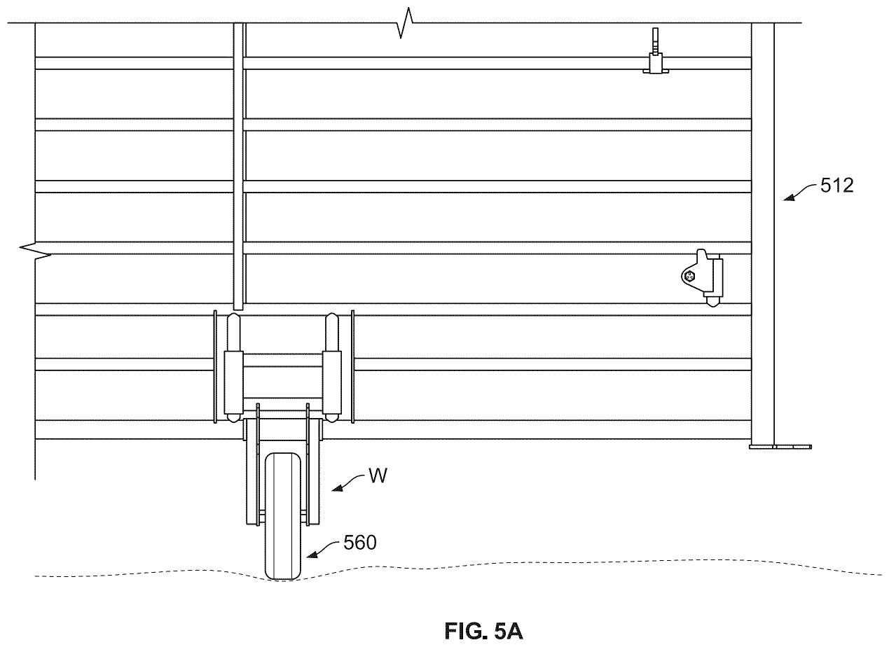

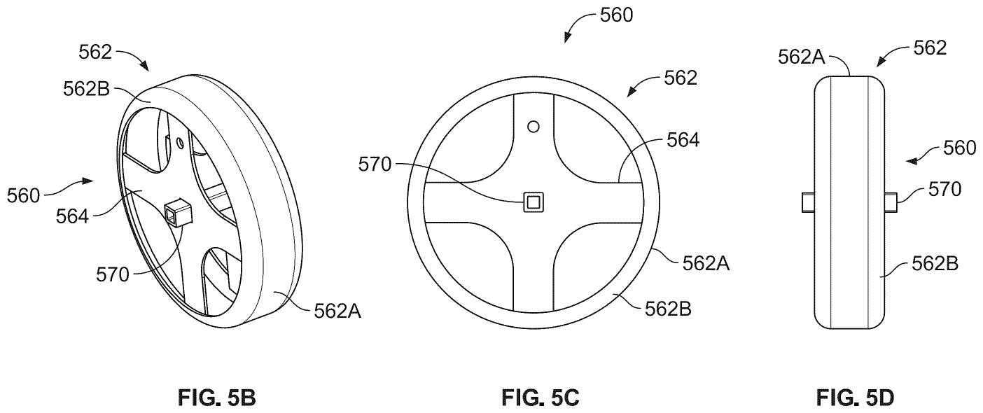

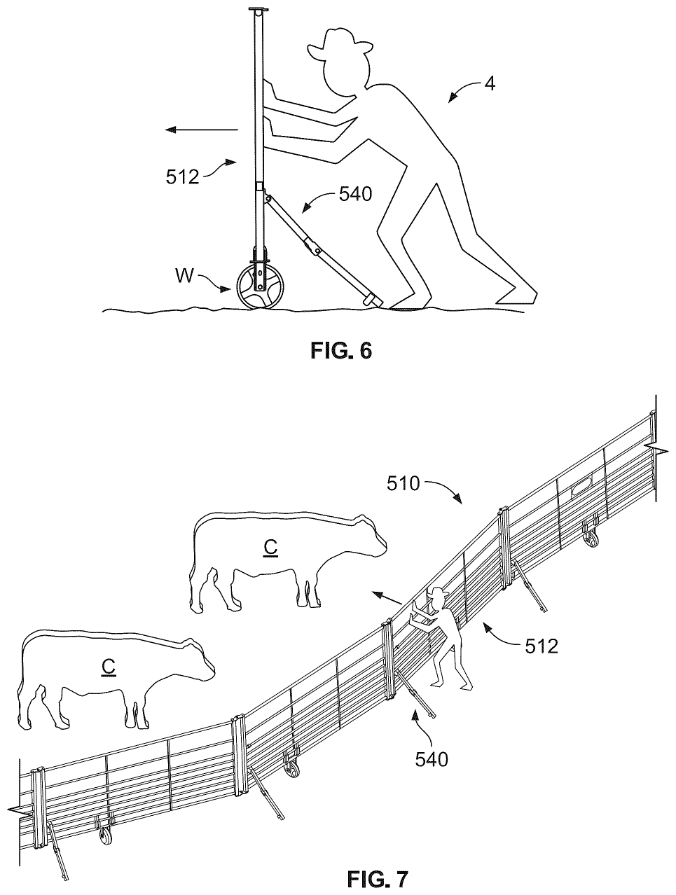

As noted above, this application incorporates U.S. Pat. No. 11,242,696 by reference. In the detailed description and in the drawings of that patent, the skilled reader will find generally that a transportable corral may be comprised of fence panels. In the embodiment described in U.S. Pat. No. 11,242,696, two sets of fence panels 12 are hinged together are able to be folded up into two sets that are able to be brought together for loading on a trailer for transport. Each fence panel is described as having upright end members and a series of generally horizontal cross members which are all preferably welded to each other. However, the skilled reader may notice that the fence panels shown in the present application appear to be shorter than those shown in U.S. Pat. No. 11,242,696, and they are. For reasons that will be explained below, the preferred length for the fence panels of this application is approximately 10 feet as opposed to 20 feet for the panels shown and described in U.S. Pat. No. 11,242,696. Each fence panel also has a latch that can be secured to the next fence panel when they are folded together. Still further, retractable wheels 562 are able to be deployed at the bottom of each fence panel to facilitate moving individual fence panels and loading sets of folded fence panels. And, as can be understood by referring to FIGS. 5 and 6 of U.S. Pat. No. 11,242,696 each wheel 562 is able to be retracted into a non-supporting position on either side of the fence panel. And finally, by referring to U.S. Pat. No. 11,242,696, the skilled reader can learn about the retractable brace assemblies (40) that can be extended toward the outside of the corral to brace each fence panel against pressure from inside the corral. When not in use, each brace assembly can be stowed between the cross members. When in use, each brace assembly is able to rotate out and down so that its distal end is in contact with the ground that is spaced away from the inside of the corral and can also do so on either side of the fence panel.

The capabilities of the above-described transportable corral may be greatly enhanced by employing a folding collapsable brace assembly 540 and by altering the steel wheels shown in FIG. 6 of U.S. Pat. No. 11,242,696 to have curved sidewalls as shown in FIG. 5A of this application. With these improvements, the transportable corral shown and described in U.S. Pat. No. 11,242,696 is transformed into a flexible, dynamic transportable corral 510 which can be used to do more than merely enclose and contain a group of livestock animals. Flexible, dynamic, transportable corral 510 may be used to coax, urge, and gently and calmly herd livestock animals toward an exit or into another area for other purposes. For example, flexible, dynamic, transportable corral 510 may be used to temporarily enclose livestock animals and then gently and calmly urge the livestock animals through an exit E in corral 510 as shown in FIG. 13, which could, for example, lead to another area or into an alleyway or perhaps into a series of semi-circular turret gates as shown and described in U.S. Pat. No. 8,100,091. In this mode, wheel assemblies 30 may preferably be left in the down or deployed position. Thus, it becomes possible for an operator or a group of operators to move adjacent fence panels so that they may be joined together thereby reducing the area of the corral. This has the effect of moving livestock animals toward an exit. This area reduction process and how the collapsable brace assemblies 540 facilitate this process and further help to provide a safer and more flexible corral will be explained in greater detail below. Moreover, as will be described below, wheel assemblies W include steel wheels which are adapted and shaped for easily skidding sideways on dirt or grass in order to facilitate the rearrangement of fence panels to change the shape and size of a corral.

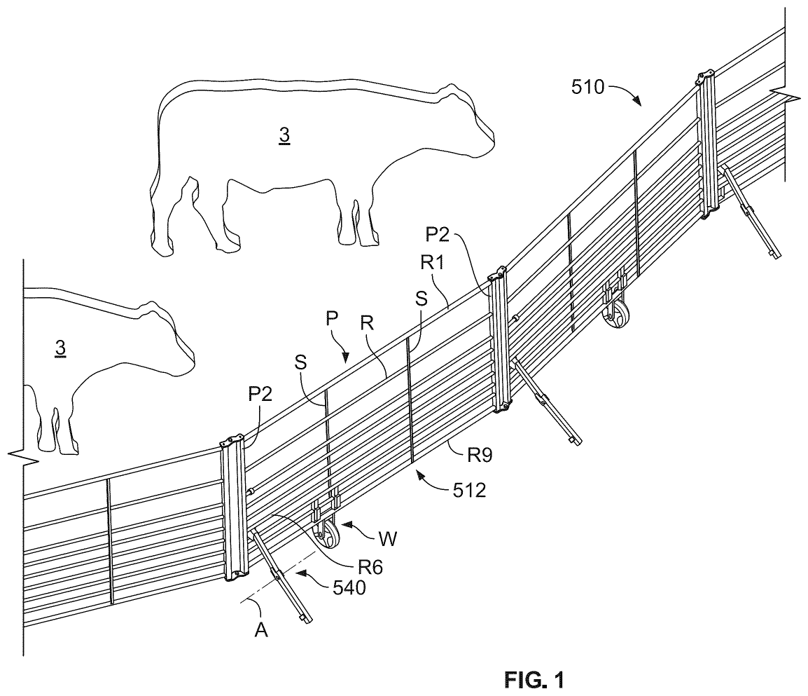

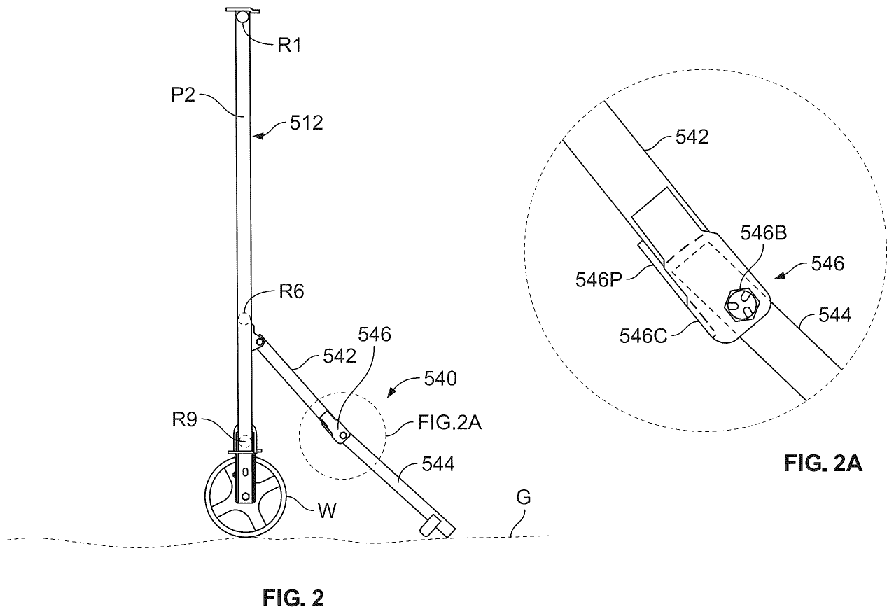

In order to understand the structure and function of flexible, dynamic, transportable corral 510, the skilled reader may refer to FIGS. 1 and 2 and first focus on just one fence panel 512 while bearing in mind that fence panel 512 is just one of a set of fence panels 512 that are hinged together in a set of fence panels, which may be only one of two sets of fence panels that make up a complete transportable corral as referred to above. Referring to the drawings, FIG. 1 is a perspective view of a portion of a flexible, dynamic, transportable corral 510 which is preferably arranged to extend to include a round corral that is able to enclose livestock animals 3. As can be seen in FIG. 1 each panel P includes opposite upright posts P2 and a set of rails R, including a top rail R1 and a bottom rail R9 as well as, in this example, upright stiffeners S that are preferably evenly spaced between posts P2. All of the rails R connect between posts P2 and are fixed to posts P2 at their opposite ends. The panel components are preferably fashioned from steel and are welded together to complete a rigid frame. In this example, each panel includes a wheel assembly W, as is further shown and described in U.S. Pat. No. 11,242,696, however, instead of using. Mounted to each of the fence panels P shown in FIG. 1 is a brace assembly 540 which will be described below.

By referring to FIG. 1, the skilled reader can see that a brace assembly 540 is shown mounted to each fence panel 512. FIGS. 2-5 show brace assembly 540 in greater detail and also show the manner in which a collapsable brace assembly 540 responds when fence panel P is acted upon by a sufficiently large and sufficiently sustained force F.

By referring to FIGS. 2-5, the skilled reader will see that brace assembly 540 is pivotally mounted at its proximate end to a rail R6 of fence panel. Rail R6 is located between top rail R1 and bottom rail R9. In this example brace assembly 540 is pivotably mounted to Rail R6 so that it is able to pivot between a retracted position for storage and transport and an extended position as shown and described in U.S. Pat. No. 11,242,696. As can be seen in FIG. 2, when brace assembly 540 is in the extended position, the distal end of brace assembly 540 contacts the ground surface G at a location that is spaced away from fence panel 512 in a direction that is away from the area that the fence is enclosing. However, it is also possible to pivot brace assembly 540 in the opposite direction to the other side of fence panel 512 if it is advantageous to do so. However, it is advantageous to deploy brace assembly 540 on the side of fence panel 512 that is opposite the livestock animals that are being enclosed.

Brace assembly 540 includes a proximate member 542 and a distal member 544 that are pivotally connected by a joint 546 that articulates about a horizontal axis A which is indicated in FIG. 1. Horizontal axis A (shown in FIG. 1) is spaced away from fence panel P and, in this example, parallel to rail R6 as well as the other rails of fence panel P. Joint 546, in this example, is a simple clevis and lug joint that is joined by a fastener (not shown) that is tightened to impose a friction bias against the articulation of joint 546. Joint 546 is also like a human knee joint in that it is arranged to only be able to pivot such that distal member 544 may only pivot in a clockwise direction with respect to proximate member 542 as viewed from the vantage of FIGS. 2-5. Distal member 544 is not able to rotate in a counter-clockwise direction (as shown in FIGS. 2-5) significantly past a generally aligned relationship with proximal member 542. Significant rotation of distal member 544 in the counter-clockwise direction (as shown in FIGS. 2-5) would cause damage to or the failure of joint 546.

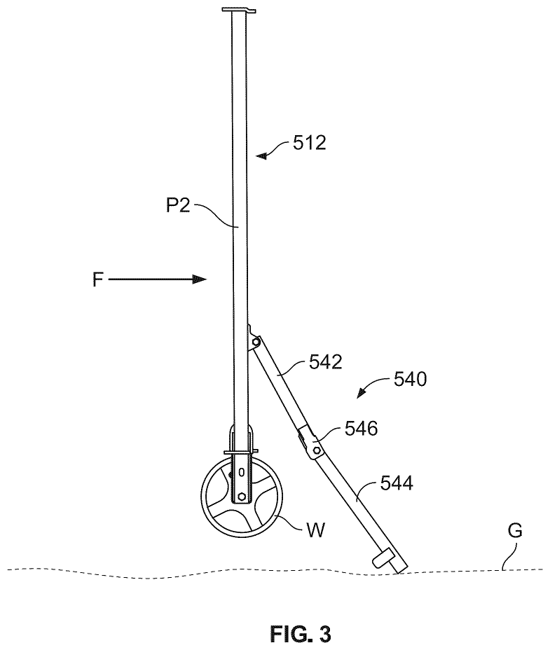

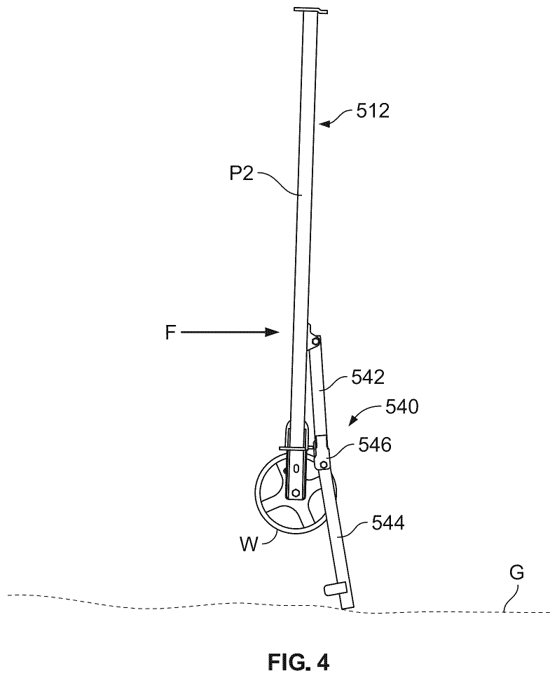

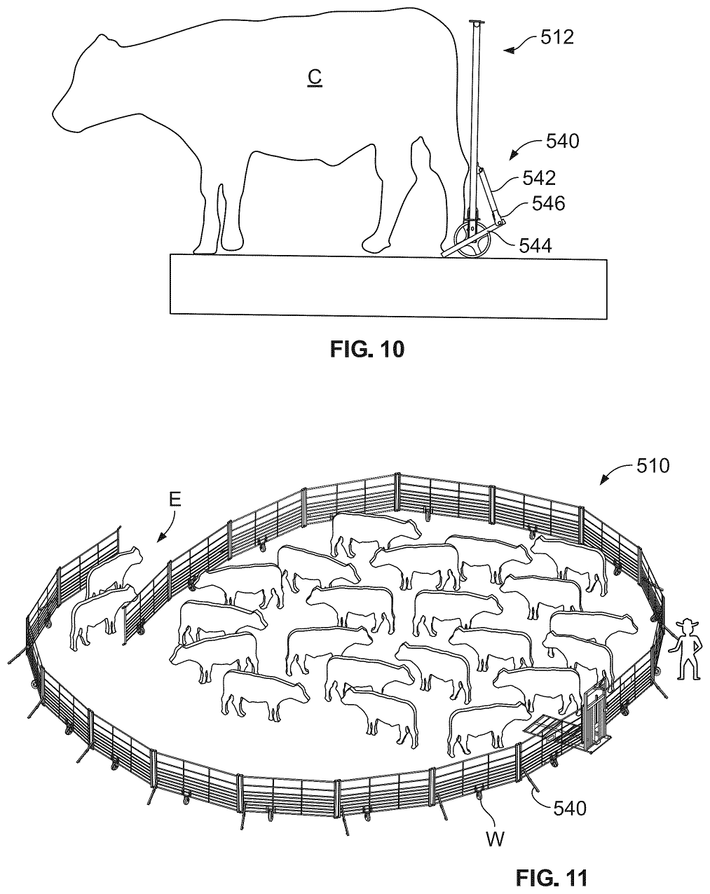

As can be seen in FIGS. 4 and 5, joint 546 of brace assembly 540 is located, such that when a livestock animal 3 applies a sustained, excessive force F to fence panel P, neither joint 546 or distal member 544 will be damaged and distal member 544 will very likely fold under bottom rail R9 of fence panel P as shown in FIGS. 5 and 10. If the distal end of brace assembly 540 is sufficiently implanted into the ground, as a large and sustained force F is applied to panel 512, then panel 512 will be lifted as shown in FIGS. 3 and 4 as panel 512 rises and translates away from the center of the enclosed area. As shown in FIG. 4, as this movement of panel 512 takes place, and the large force F continues to be applied to fence panel 512, fence panel 512 and brace assembly 540 will come into contact at joint 546. As shown in FIGS. 4 and 5, as brace assembly 540 pivots toward the fence panel, bottom rail R9 of the panel will contact joint 546 of brace assembly 540 (either directly or indirectly) to cause joint 546 to yield and articulate as distal member 544 of brace assembly 540 folds under bottom rail R9 of fence panel 512. In this way, brace assembly 540 provides support for fence panel 512 while also allowing sufficient flexibility in the fence structure to reduce the potential for injuring livestock animals that are enclosed within the fence structure. Brace assembly 540 is not harmed by the above-described movements. On the contrary, brace assembly 540 is not damaged or destroyed and remains undamaged to fight another day. Brace assembly 540 is an integral part of a flexible, dynamic corral structure that can be used to incrementally coax livestock animals toward desired objectives.

FIG. 2A is a close up side view of joint 546 of brace assembly 540 taken from zone 2A indicated in FIG. 2. Joint 546 is merely one example of how a joint may be arranged so that distal member 544 is not able to rotate counter-clockwise with respect to proximal member 542 as viewed from the perspective shown in FIG. 2 but, with resistance, is able to rotate in a clockwise direction from the position shown in FIG. 2 to the position shown in FIG. 5. In this example, a clevis fitting 546C is fixed to proximal member 542. Clevis 546C includes a stop plate 546P. However, opposite stop plate 546P, clevis 546C is open to allow the passage of the upper end of distal member 544 as distal member 544 rotates about a bolt 546B in a clockwise direction. However, if a force is applied to joint 546 to urge distal member 544 to rotate in a counter-clockwise direction, the upper end of distal member 544 shown as hidden lines in FIG. 2A will be stopped by stop plate 546P. Preferably, bolt 546B is sufficiently tightened so that there is resistance to the rotation of distal member 544 even in the clockwise direction. Thus, when in the extended position as shown in FIG. 2, because of the friction in joint 546, brace assembly 540 handles as if it is a one-piece rigid member. As can be seen in FIG. 5, joint 546 of brace assembly 540 is designed to fold when stop plate 546P comes in contact either directly or indirectly with the bottom rail of fence panel 512.

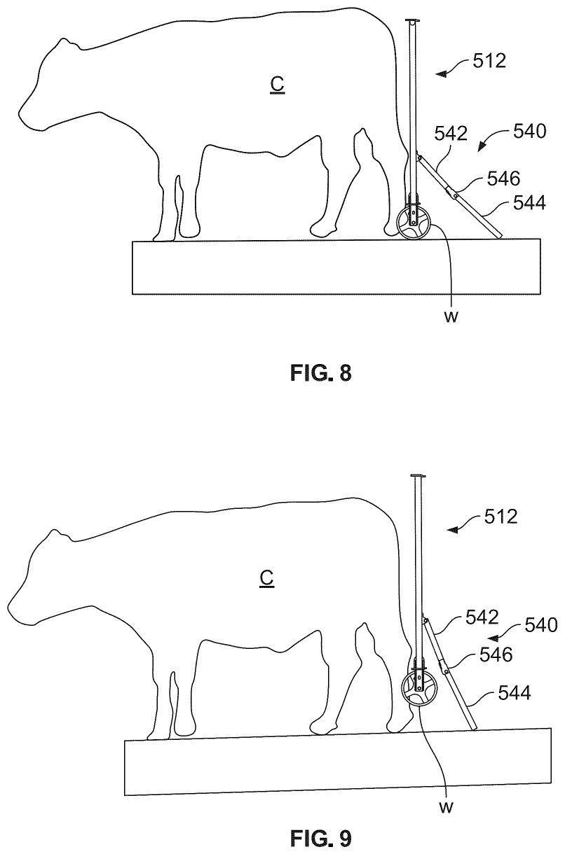

Another advantage afforded by collapsable brace assembly 540 is that once a livestock animal has forced brace assembly 540 over center as shown in FIGS. 4 and 5, brace 540 quickly assumes the position shown in FIGS. 5 and 10. FIGS. 8-10 illustrate how a livestock animal C might be able to push and elevate a fence panel 512 until brace assembly 540 buckles as the distal portion 544 of brace assembly 540 folds under fence panel 512. A rigid brace having no joint would continue to support the fence panel (or section of fence) in an elevated position which would encourage or allow smaller livestock animals, calves for example, to attempt to escape under the elevated fence panel. It is advantageous for brace assembly 540 to buckle and fold prior to being reset back to the position shown in FIGS. 2 and 8 by an operator who is working outside the corral.

As show in FIGS. 5A-5D wheel 560 from wheel assembly W has changed significantly from the wheel shown and described in U.S. Pat. No. 11,242,696. The extendible and retractable structure for mounting each wheel assembly W to each fence panel 512 has not changed from what is shown and described in U.S. Pat. No. 11,242,696. However, instead of using a plain cylindrical steel wheel (as shown in FIG. 6 of U.S. Pat. No. 11,242,696), wheel 560 shown in FIG. 5A (of this application) is fashioned to present a curved skid like profile to facilitate sideways sliding sideways in the direction of rails R of fence panel 512. Wheel 560 shown in FIG. 5A of this application includes a “tire” portion 562 and spoke members 564 that extend from a hub 570 to the tire portion 562. In this example, steel tire portion 562 has a central cylindrical portion 562A and rounded curved sidewalls 562B. Central cylindrical portion 562A is preferably flat in the direction that is parallel to the axis of rotation of wheel 560. Rounded, curved sidewalls 562B extend from each opposite edge of central cylindrical portion 562A and curve inwardly toward hub 570. The purpose of steel tire portion 562 is to have a very low coefficient of friction with any surface, particularly any surface comprised of soil or grass. Accordingly, this design permits sliding movement of a fence panel 512 or even a set of fence panels 512 in a direction that not normal to the fence panels and even, when necessary, in a direction that is parallel to rails R of fence panels 512. It is important that tire portion 562 be shaped to present a skid-like surface when being dragged across a surface in either direction that is parallel to rails R of fence panel 512. Accordingly, wheels 560 are able to act as skids that offer a low, manageable amount of friction if a fence panel 512 is pulled in a direction that is generally parallel to direction of its fence rails.

The fence panels shown and described in U.S. Pat. No. 11,242,696 and the fence panels of flexible, dynamic transportable corral 510 preferably have one wheel assembly W per fence panel. Because flexible, dynamic transportable corral 510 can be deployed by operators who are then able to reshape and re-form an enclosure by moving and folding fence panels and to be able to do so, it is advantageous to have shorter more compact fence panels 512. The skidding movement of the steel wheels 560 as described above is easier when the length size and weight of each fence panel 512 that is carried by each wheel 560 are limited. In this example, the applicant has found that fence panels that are 10 feet in length are suitable for a flexible, dynamic transportable corral 510, while longer, heavier fence panels are less suitable.

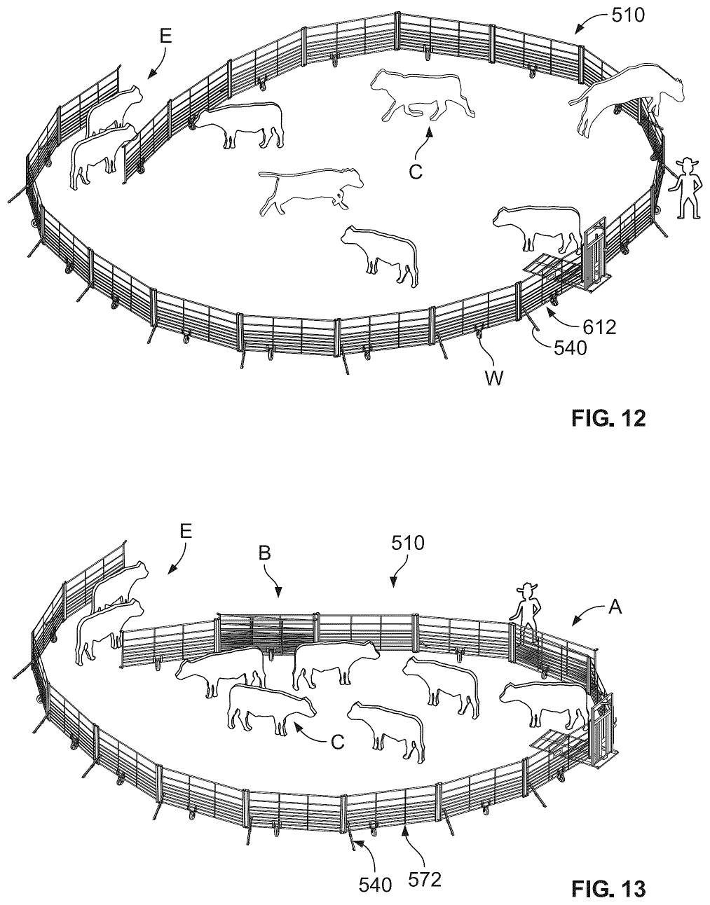

FIGS. 11-13 show how a flexible, dynamic transportable corral 510 may be manipulated to gently coax livestock animals from a temporary pen through an exit E in that pen. The skilled reader should note that all of the fence panels are as shown in FIGS. 1-10. The skilled reader may also notice that wheels W are in the extended, operating position. Also, each fence panel 512 has a collapsable brace assemblies 540 that is in the extended supporting position as shown in FIGS. 1, 2, 6, 7 and 8. This is a desirable configuration if the corral is to be used to enclose livestock animals C for a limited period of time. Operator may decide to retract wheels W if the corral is to enclose livestock animals C for an extended period of time. With the wheels W extended, it is relatively easy for operators to move fence panels 512 even though adjacent fence panels are hinged together.

By referring to FIG. 13, the skilled reader is able to see that operators have folded and latched together adjacent fence panels 512 in zones A and B (by using latch mechanisms as described in U.S. Pat. No. 11,242,696). Such actions by operators would appear substantially as shown in FIG. 6. Such folding maneuvers will result in reducing the perimeter and area of corral 510. Thus, it is possible, for operators to gradually reduce the perimeter and the area of corral 510 in order to incrementally urge livestock animals to exit though exit E. And conversely, as a corral is being filled with animals, operators may begin with a corral with several folded zones and then unlatch and unfold fence panels in order to expand both the perimeter and area in order to accommodate an increasing number of animals while maintaining an appropriate density of animals per unit area.

A gradual method for calmly urging livestock animals through an exit E is facilitated by a number of factors. First, corral 510 preferably has a round shape throughout the procedure. This is preferable particularly for cattle and is probably preferable for other grazing animals which often prefer gathering in circular formations. In the case of a flexible, dynamic transportable corral 510 that is arranged in a round shape with an exit E as shown in FIG. 11, the perimeter and area may be gradually and incrementally reduced. This perimeter reduction operation is facilitated by the brace assemblies 540 that are able to yield to excessive forces and which can be easily reset. The perimeter reduction operation is also facilitated by the slick steel wheels 562 that are able to function as skids when fence panels 512 are slid in a sideways direction as fence panels 512 are being folded and latched together to reduce the corral perimeter. In some cases, it is envisioned that cattle will move in a circular, swirling pattern and calmly exit through exit E as shown in FIGS. 11-13.

The collapsable brace assemblies 540 play an important role when flexible, dynamic corral 510 is being reduced as described above. At various points in the process, livestock animals may apply large forces to portions of corral 510. The best result is obtained if livestock animals encounter a flexible barrier. This reduces the likelihood of an animal being injured. After a brace assembly 540 collapses and is in the condition shown in FIGS. 5 and 10, an operator may merely pull on the proximal member 542 and reset the brace to the position shown in FIGS. 2 and 8. Thus, the method employed by operators as they reduce the perimeter and area of the corral may have a ratchet-like quality as if by two steps forward and one step back. Occasionally, it will be necessary to reset the brace assembly and then begin again with the movement and folding of adjacent panels.

From the above description a skilled reader will appreciate that a transportable corral that has the features described above will be flexible, dynamic and transportable. It will offer significant advantages for operators who are gathering and moving livestock animals. As noted above, the fence panels of the flexible, dynamic transportable corral are limited in length and therefore limited in weight. The fence panels can be braced by braces that will yield when subjected to sufficiently large forces and those braces can be easily reset. It is easy to move fence panels to partially fold up the perimeter of a corral in order to reduce its area because the wheels will easily roll as the fence panel is moved in a transverse direction, but will also easily slide on its skid-shaped steel surface when moved in a longitudinal direction. This provides a flexible dynamic transportable corral which is ideal for operators for working and moving livestock animals who are also then able to work from outside the temporary corral instead of working inside an inflexible, rigid corral structure in close proximity with large livestock animals which often have immense weight and strength.

It is to be understood that while certain forms of this invention have been illustrated and described, it is not limited thereto, except in so far as such limitations are included in the following claims and allowable equivalents thereof.

Having thus described the invention, what is claimed as new and desired to be secured by Letters Patent is:

1. A transportable corral, comprising;
a plurality of fence panels that are hinged to each other in an end-to-end manner thereby defining a fence panel set that extends between a first fence panel and a last fence panel, the fence panels further including latches for selectively folding and latching fence panels to each other in order to reduce the length of the fence set or the perimeter of an enclosed area that is enclosed to the fence panel set,
each fence panel presenting a wheel assembly that is able to be moved between a retracted position for not supporting the fence panel and an extended position for supporting the fence panel for facilitating movement and positioning of the fence panel, each wheel assembly having a wheel that present low friction steel surfaces so that the fence panel may be rolled in a normal direction in relation to the fence panel or slid in a parallel direction in relation to the fence panel,
each fence panel further including a brace assembly which includes a proximal member that is pivotably joined to the fence panel so that the brace assembly may be extended to one side of the fence panel, the brace assembly also having a distal member that is hinged to the distal end of the proximal member by a joint that is arranged to permit the distal member to fold under the fence panel if the fence panel is subjected to an excessive force from a direction that is opposite the direction of extension of the brace assembly.
